(19) United States
(12) Patent Application Publication
(10) Pub. No.: US 2003/0006562 A1
(43) Pub. Date: Jan. 9, 2003

(54) Piston ring

(75) Inventor: Norbert Feistel, Ellikon a.d. Thur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Burckhardt Compression AG, Winterthur (CH)

(21) Appl. No.: 10/191,962

(22) Filed: Jul. 8, 2002

(30) Foreign Application Priority Data
Jul. 9, 2001 (EP) 01810674.0

(51) Int. Cl. F16J 9/00

(52) U.S. Cl. 277/434

(57) ABSTRACT

The piston ring (10) for a dry-running piston compressor consists of a first and a second ring part (10a, 10b) having gaps or butt joints (10e, 10f). These two ring parts (10a, 10b) are arranged to lie mutually concentric with respect to an axis (C). The first ring part (10a) has an essentially L-shaped cross-section, having a first arm (10h) running in the direction of the axis (C) and a second arm (10g) extending outwards in a direction essentially radial to the axis (C). The second arm (10g) has a first bearing surface (10l) and the second ring part (10b) has a second bearing area (10k). The first and the second bearing areas (10l, 10k) are designed to fit perfectly on top of each other. The first and second bearing areas (10k, 10l) exhibit a discontinuity (U1,U2).

The invention relates to a piston ring according to the preamble of claim 1.

The publication WO 97/19280 discloses a piston ring for a dry-running piston compressor, in which the piston ring is composed of two ring parts, which are fabricated from a plastic material such as PTFE for example. This piston ring has the disadvantage, that it undergoes motion in the radial direction, also described as a fluttering motion, when the pressure fluctuates and particularly when reversals in gas flow occur near the piston ring. This can cause an increased wear of the piston ring, which results in an insufficient service life of the piston compressor. A piston ring having a good and constant sealing efficiency over long times is particularly necessary for the compression of very light gases such as hydrogen.

It is the object of the present invention for a dry-running piston compressor, particularly for the compression of very light gases, to produce an economically more profitable, especially low-wear piston ring.

This object is achieved by a piston ring having the characteristics of claim 1. The subsidiary claims 2-8 relate to further favourable piston ring designs.

In particular, the object of the invention is achieved by a piston ring composed of first and second ring parts having gaps or butt joints, in which both ring parts are arranged to lie on top of each other and concentrical with respect to a common axis. The first ring part exhibits an essentially L-shaped cross-section having a first arm extending in the direction of the axis, and a second arm extending outwards in a direction essentially radial to the axis. The second arm has a first bearing surface and the second ring part has a second bearing surface. The first and second bearing surfaces are so designed that they fit perfectly on top of each other. The first and second bearing surfaces exhibit a discontinuity.

The first and second bearing surfaces of both ring parts each exhibit a discontinuity, which is designed either as a kink or a shoulder. These discontinuities run preferably in a direction concentric to the said axis. The discontinuities are preferably arranged in such a way that the discontinuities of both ring parts, which lie on top of each other, are arranged to be congruent. These discontinuities result in the two ring parts being mechanically coupled to each other in relation to inwards or outwards motion in the radial direction, so that a radial motion of one ring part, independent from the motion of the other ring part, is no longer possible. A reciprocal fluttering motion between the two ring parts is prevented by this mechanical coupling, so that the piston ring according to the invention exhibits a very slight wear.

In dry-running piston compressors no lubricant is available to grease the piston rings and in addition to act as a seal. For this reason, metallic piston rings are not suitable for such a dry-running application. The frictional pairings used in dry-running applications work on the basis of solid lubricants which are contained in one of the frictional partners. For this reason, the piston ring according to the invention is made of a plastic material especially modified for dry-running with solid lubricants such as PTFE, graphite or molybdenum sulphide.

Sealing elements having a very high sealing efficiency are essential primarily for the compression of very light gases to a very high pressure, as is the case with hydrogen for example, in order to keep the leakage as tiny as possible. A high sealing efficiency can be achieved by combining two piston rings to form a twin ring for example, such that no bumping or continuous gaps result.

The self-lubricating effect of the dry-running frictional seals has the consequence that the piston rings supplying the lubricant gradually wear out. The piston ring well known from the state of the art has the disadvantage that, when there is a reversal of gas flow, both ring parts can be moved against each other in the radial direction and a fluttering motion occurs as a result. Since the pressure distribution is not a constant at those regions of the surfaces of the two rings, which face the cylinder wall and make the seal, the ability to move in a radial direction results in one of the two ring parts wearing out faster than the other. This uneven wear causes the two ring parts no longer to overlap each other completely, so that gaps are created and large amounts of gas leakage occurs particularly in the case of very light gases under high pressure. This fact impairs the output of the dry-running compressor considerably. The piston ring according to the invention is particularly suitable for the dry-running compression of very light gases up to a high compression pressure. The piston ring has the advantage that during operation a uniform harmonious wear takes place, owing to the construction consisting of two ring parts and the mutual coupling brought about by the discontinuities on the bearing surfaces. Both ring parts are pressed against each other by the pressure of the fluid to be compressed, and when the pressure reverses, both ring parts are locked together by the discontinuities, so that during operation either no or only a tiny amount of motion relative to each other occurs, so that for example the sealing surfaces of both ring parts facing a cylinder wall experience a uniform removal of material. In this way, either no or only slight local points of leakage can form, which results in the sealing efficiency of the piston ring in dry-running compressors remaining approximately constant over a long operating life.

A further advantage of the piston ring according to the invention is the fact that the gap between the opposite bearing surfaces does not or hardly becomes dirty because of the mutual coupling of both ring parts.

The invention will be explained further using several example designs.

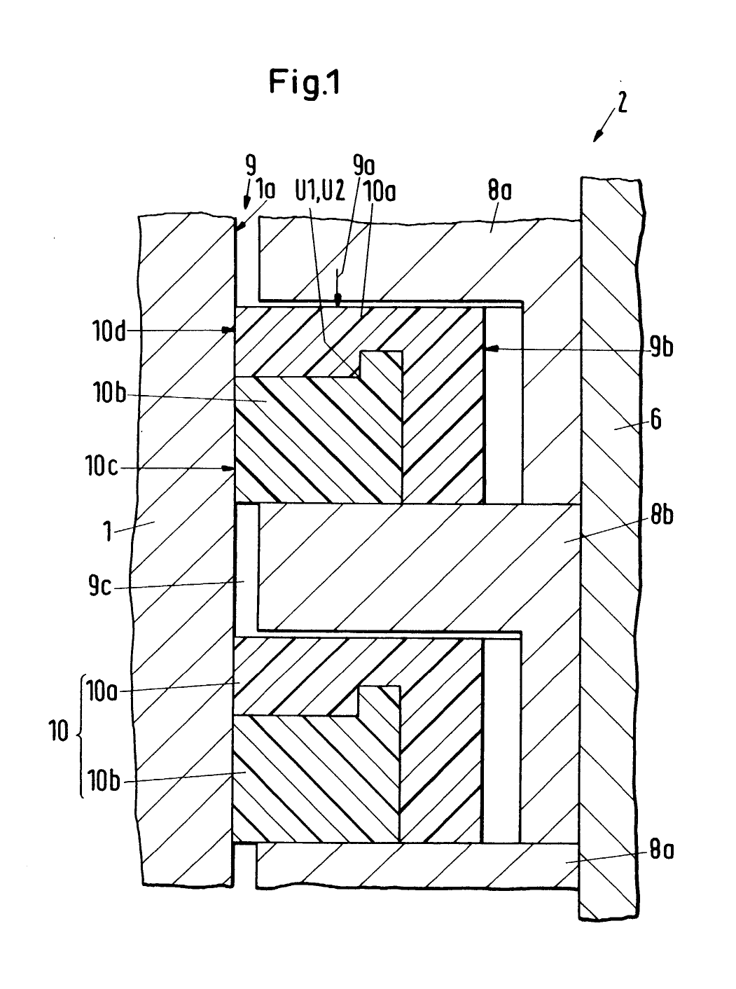

FIG. 1 shows a longitudinal section through a dry-running piston compressor showing piston, piston rings and cylinder.

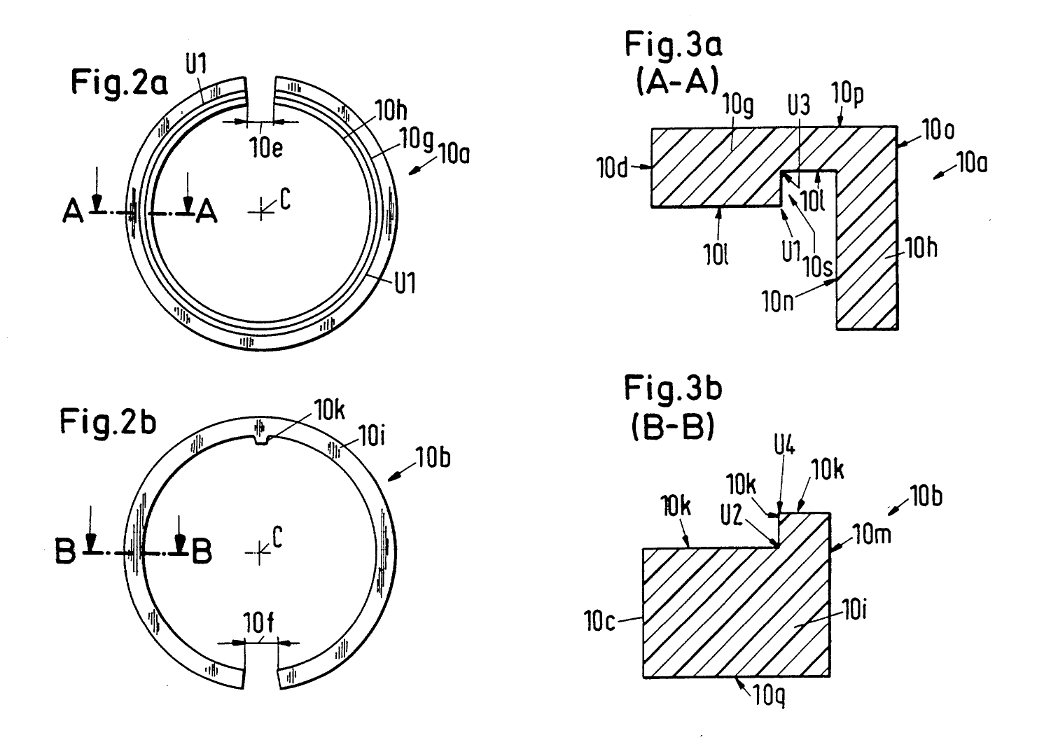

FIG. 2a is a plan view of a first ring part.

FIG. 2b is a plan view of a second ring part.

FIG. 3a is a cross-section along the section line A-A through the first ring part.

FIG. 3b is a cross-section along the section line B-B through the second ring part.

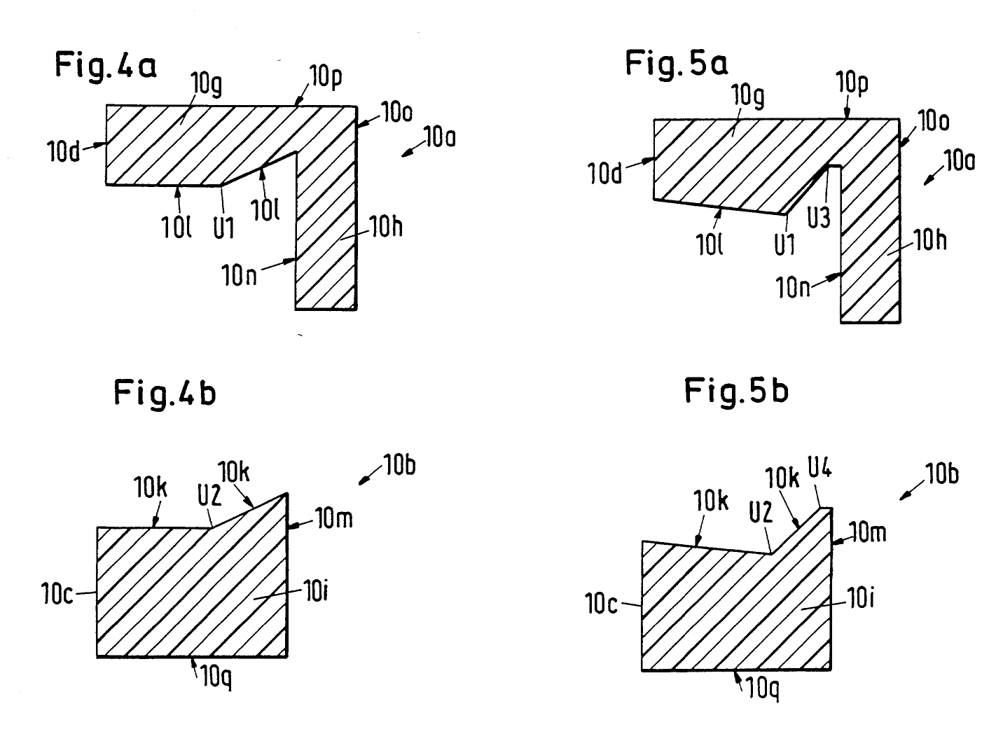

FIG. 4a is a cross-section through a second example design of a first ring part.

FIG. 4b is a cross-section through a second example design of a second ring part.

FIG. 5a is a cross-section through a third example design of a first ring part.

FIG. 5b is a cross-section through a third example design of a second ring part.

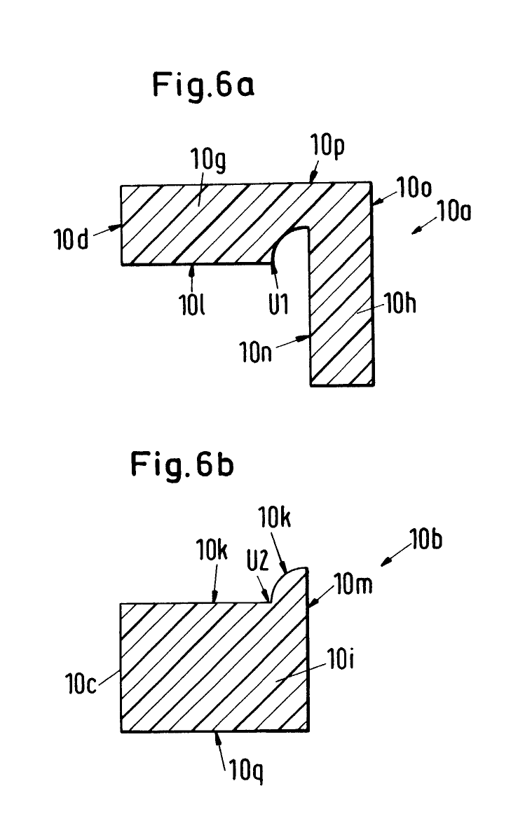

FIG. 6a is a cross-section through a fourth example design of a first ring part.

FIG. 6b is a cross-section through a fourth example design of a second ring part.

FIG. 1 shows a longitudinal cross-section through a dry-running piston compressor having a cylinder 1, in which a piston 2, which is partly represented, is arranged to be movable upwards and downwards. The lower end of the piston 2 merges into a piston rod, which is connected to a crank mechanism in a well known, not shown way. Above piston 2 there is a compression chamber in which in a well-known, not shown way a gas to be compressed is sucked in during the downstroke of the piston 2, compressed during the following upwards stroke and expelled from the compression chamber. The piston 2 comprises a sleeve 6 which is connected to the piston rod. Along the sleeve 6 seven piston rings 10 as an example are arranged one upon the other and mutually separated. Piston 2 is designed to be an assembly, in which the individual parts of the piston 2 as well as the piston rings 10 are held together by a nut screwed on to the upper end of the piston 2. The piston 2 has a central axis C.

The assembled piston 2, shown, is produced from individual parts and consists of the sleeve 6 running in the axial direction, the chamber rings 8a, 8b arranged around the sleeve, as well as the piston rings 10 arranged in the slots. These piston rings 10 are made up in each case of a first ring part 10a and a second ring part 10b. Both ring parts 10a, 10b are designed to fit each other in such a way, that the parts of the surfaces which touch each other come to lie in a positive fit on top of each other. Both ring parts 10a, 10b possess surfaces 10c, 10d respectively, which face the cylinder wall 1 and perform a sliding motion upwards and downwards along the cylinder wall 1 during the operation of the piston 2.

The first ring part 10a is arranged in the cylinder 1 towards the pressure side. In this case, the gas pressure 9 exerts forces on the first ring part 10a in the axial direction 9a as well as in the radial direction 9b, so that the whole piston ring 10 is pressed first against the inner wall la of the cylinder 1 in the radial direction and second in the axial direction against the limiting surface of the groove which is away from the pressure side. In this way the sealing efficiency of the piston ring 10 during operation is increased and both ring parts 10a, 10b are held together in the groove in a positive fit without a relative motion between them. A pressure reversal can occur during the expansion stroke of the piston, when for example the gas pressure 9 at the pressure side becomes lower than the pressure in the inner cavity 9c. This results in a reversal of gas flow in the region of the piston ring 10, in which remaining gas flows out of the inner cavity 9c upwards in the arrangement according to FIG. 1. Both ring parts 10a, 10b are coupled firmly to each other with respect to motion in the radial direction also during this reversal in gas flow, so that both ring parts 10a 10b perform the same motion and therefore no relative motion between them occurs. This mutual positive connection results in those surface regions 10c, 10d of both ring parts 10a, 10b, which slide and rub against the cylinder wall 1a, wearing out in a uniform fashion, so that no local leakage points are created and both ring parts 10a, 10b rest against the cylinder wall la having the same efficiency over a long operational lifetime.

The piston ring 10, illustrated in FIG. 1, and consisting of the ring parts 10a, 10b is shown in a plan view in FIGS. 2a, 2b and in cross-section in FIGS. 3a, 3b. Both ring parts 10a, 10b have a basically circular shape and are concentric relative to a central axis C. FIG. 2a shows the first ring part 10a of the piston ring 10, which is a ring shaped element designed to have an L-shaped or approximately L-shaped cross-section, and a gap or butt joint 10e. This ring part 10a has two arms 10g, 10h, a first arm 10h extending in a direction parallel to the axis C and a second arm 10g extending outwards in a direction radially or approximately radially to the axis C. The width of the gap or butt joint 10e is designed in such a way that a certain spring-like motion is possible for the first ring part 10a along its circumference.

FIG. 3a shows a cross-section through the first ring part 10a along the section line A-A according to FIG. 2a. The first ring part 10a, having an L-shaped design, has a first arm 10h, which extends parallel to the axis C and has an outer surface 100 and an inner surface 10n. The second arm 10g, which extends in a direction radial to the axis C, has an outer surface 10p, which extends in a direction perpendicular to the axis C. The inner surface 10l exhibits a steps 10s, which extends parallel to the axis C, so that a discontinuity is formed at the points U1 and U3. The term “discontinuity” is used to signify the characteristic that the extension of the surface exhibits a kink. As can be seen from FIG. 2a, the inner surface 10l has a groove running around the first arm 10h caused by the step 10s. FIG. 3b shows a cross-section of a second ring part 10b along the section line B-B according to FIG. 2b. The second ring part 10b is designed to fit the shape of both inner surfaces of the first ring part 10a in a corresponding manner. The ring element 10i has four faces, the face 10c facing the cylinder wall, the face 10q facing the chamber ring 8, as well as the two faces 10m, 10k facing the first ring part 10a. The two last named bearing surfaces 10m, 10k are designed to match the first ring part 10a in such a way that the bearing surfaces 10m 10k will rest against the two bearing surfaces 10l, 10n in a positive fit when the ring parts 10a, 10b are arranged one inside the other.

FIG. 2b shows a plan view of the second ring part 10b, which exhibits a gap or butt joint 10f and a tappet 10k lying opposite to it and projecting towards the axis C. When the piston ring 10 is assembled, the second ring part 10b is positioned above the first ring part 10a while keeping the orientations shown in FIGS. 2a, 2b, so that the tappet 10k will lie in the gap or butt joint 10e of the first ring part 10a. As a result both ring parts 10a, 10b are prevented from rotating relative to each other. It is advantageous if the tappet 10k is designed to be narrower than the size of the gap or butt joint 10e, so that the second ring part 10a maintains a certain freedom of movement along its circumference at the gap or butt joint 10e.

The piston ring 10, illustrated in FIGS. 2a, 2b, 3a, 3b, has the advantage that it is particularly inexpensive to manufacture. This is because the step 10s in the first ring part 10a is easy to fabricate and both ring parts 10a, 10b exhibit no slanting surfaces, but surfaces which are only parallel or perpendicular to each other. This fact makes the production inexpensive and a simple control of the dimensional stability and the tolerances of the manufactured ring parts 10a, 10b possible.

FIG. 1 shows an assembled piston 2, in which the piston rings 10 are arranged. Instead of being an assembled piston 2, piston 2 could however exhibit a ring cavity formed by a groove running round the piston, in which the piston ring 10, for example the illustrated piston ring 10 in FIGS. 2a, 2b, 3a, 3b, is arranged. Thus, the piston ring according to the invention is not just suitable for an assembled piston 2.

The FIGS. 4a and 4b show in cross-section a further example design for a piston ring 10, comprised of the first ring part 10a and the second ring part 10b. The first bearing surface 10l of the first ring part 10a exhibits a discontinuity U1. The discontinuity U1 runs concentrically to the axis C. The first bearing surface 10l extends outwards from the discontinuity U1 in a direction perpendicular to the axis C or parallel to the surface 10p. The first bearing surface 10l extends inwards from the discontinuity U1 at a constant angle, so forming a cone. The second bearing surface 10k of the second ring part 10b is designed to fit to the first bearing surface 10l and exhibits a discontinuity U2. The FIGS. 5a and 5b show in cross-section a further example design for a piston ring 10 comprised of the first ring part 10a and the second ring part 10b. The first bearing surface 10l of the first ring part 10a exhibits two discontinuities U1 and U3. The discontinuities U1 and U3 run concentrically to the axis C. The second bearing surface 10k of the second ring part 10b is designed to be a perfect fit to the first bearing area 10l and exhibits the two discontinuities U2 and U4.

The FIGS. 6a and 6b show in cross-section a further example design for a piston ring 10 comprised of the first ring part 10a and the second ring part 10b. The first bearing surface 10l of the first ring part 10a exhibits a discontinuity U1. The discontinuity U1 runs concentrically to the axis C. The first bearing surface 10l extends outwards from the discontinuity U1 in a direction perpendicular to the axis C or parallel to the surface 10p. The first load bearing area 10l extends inwards from the discontinuity U1 having a profile in the form of a segment of a circle. The second bearing surface 10k of the second ring part 10b is designed to be a perfect fit to the first bearing surface 10l and exhibits a discontinuity U2.

An advantage of the piston ring 10 according to the invention can be seen from the fact that the bearing surfaces 10l, 10n, 10k, 10m of the two ring parts 10a, 10b are coupled together in a positive connection, also during the operation of the piston ring 10 over a long period. The two ring parts 10a, 10b are designed in such a way, that a direct action of the gas 9 under pressure on the faces 10l, 10n, 10k, 10m is prevented as much as possible. The gas pressure 9 acting on the ring parts 10a, 10b usually works on the junction 10f and causes a force acting in a direction along the circumference of the second ring part 10b. Due to the interlocking of the second ring part 10b in the first ring part 10a, despite this force no lifting of the second ring part 10b from the first ring part 10a occurs, so that the gas pressure cannot act directly on the faces 10l, 10n, 10k, 10m. A direct action of the gas pressure on the faces 10m, 10k of the second ring part 10b would result in a relatively rapid wearing out of the second ring part 10b. In order to prevent this effect, the piston ring 10 according to the invention has ring parts 10a, 10b exhibiting discontinuities U1, U2, which prevent any relative lifting of the second ring part 10b from the first ring part 10a. According to FIG. 1, the piston ring 10 is pressed in the axial direction against the chamber ring 8b by the action of the gas 9a and in the radial direction against the wall la of the cylinder 1 by the action of the gas 9b. The first ring part 10a, loaded with this pressure, exerts corresponding forces on the second ring part 10b. Because of the interlocking design of the bearing surfaces 10l, 10k, the forces acting due to the gas pressure bring about an increased mutual support of the two ring parts 10a, 10b, so that the bearing surfaces 10k, 10l, 10m, 10n are pressed more firmly against each other. In this way, a direct action of the gas pressure on the bearing surfaces 10k, 10l, 10m, 10n is prevented.

There are many possible ways of designing the faces 10k, 10l, 10m, 10n in such a way, that the bearing surfaces 10k, 10l exhibit a discontinuity U1, U2. The radial cross-sections illustrated in the FIGS. 3a to 6b exhibit discontinuities U1, U2, U3, U4 which are formed by triangular or rectangular sections or sections in the form of a segment of a circle. Other section designs are of course possible, which have the characteristic, that they form at least one discontinuity U1, U2 in the first and second ring parts, 10a, 10b.

The ring parts 10a, 10b are formed of a plastic, in particular of plastics such as polytetrafluoroethylene (PTFE), a modified high-temperature polymer such as polyetheretherketone (PEEK), polyetherketone (PEK), polyimide (PI), polyphenylene sulphide (PPS), polybenzimidazole (PBI), polyamide imide (PAI) or a modified epoxy resin. The high-temperature polymers are plastics which are not capable of dry running in pure form, so that the above named plastics are usually filled with additional solid lubricants such as e.g. carbon, graphite, molybdenum disulphide or PTFE.

1. Piston ring (10) for a dry-running piston compressor, consisting of a first and a second ring part (10a, 10b) having gaps or butt joints (10e, 10f, in which the two ring parts (10a, 10b) are arranged to be mutually concentric relative to an axis (C) and the first ring part (10a) exhibits an essentially L-shaped cross-section having a first arm (10h) which extends in the direction of the axis (C) as well as a second arm (10g) extending outwards essentially in a direction radial to the axis (C), and in which the second arm (10g) has a first bearing surface (10l) and the second ring part (10b) has a second bearing surface (10k), and in which the first and the second bearing surfaces (10l, 10k) are designed to fit perfectly on top of each other, wherein the first and the second bearing surfaces (10k, 10l) exhibit discontinuities (U1, U2).

2. A piston ring (10) according to claim 1, wherein the discontinuities U1, U2 are arranged to be situated on top of each other.

3. A piston ring (10) according to one of the previous claims, wherein the discontinuities (U1, U2) run concentrically to the axis (C).

4. A piston ring (10) according to one of the previous claims, wherein the second ring part (10b) rests against the first arm (10h) of the first ring part (10a).

5. A piston ring (10) according to one of the previous claims, wherein the bearing surfaces (10k, 10l) extend in a direction perpendicular or essentially perpendicular to the axis (C) outwards from the discontinuity (U1, U2).

6. A piston ring (10) according to one of the previous claims, wherein the radial cross-section through the first and second ring parts (10a, 10b) exhibits a section, which starts from the discontinuity (U1, U2) and runs inwards, having a triangular or rectangular shape, or is in the shape of a segment of a circle.

7. A piston ring (10) according to one of the previous claims, wherein the bearing surfaces (10k, 10l) exhibit a step in the region of the discontinuity (U1, U2), which runs parallel or essentially parallel to the axis (C).

8. A piston ring (10) according to one of the previous claims, wherein, the first and/or the second ring parts (10a, 10b) is made of a material from the group of polytetrafluoroethylene (PTFE) polymers, modified high temperature polymers such as polyetheretherketone (PEEK), polyetherketone (PEK), polyimide (PI), polyphenyl sulphide (PPS), polybenzimidazole (PBI), polyamide imide (PAI) or a modified epoxy resin, these materials possibly containing additional solid lubricants such as carbon, graphite, molybdenum sulphide or PTFE.

9. A dry-running piston compressor having a piston ring according to one of the previous claims.
